(19) United States
(12) Patent Application Publication
(10) Pub. No.: US 2008/0233274 A1
(43) Pub. Date: Sep. 25, 2008

(54) Manufacturing method of tantalum condenser

(75) Inventor: Gi Ahn Lee, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/007,194

(22) Filed: Jan. 8, 2008

(30) Foreign Application Priority Data
Mar. 19, 2007 (KR) 10-2007-0026573

(51) Int. Cl. B05D 5/12

(52) U.S. Cl. 427/79

(57) ABSTRACT

There is provided a method of manufacturing a tantalum condenser, in which a high-performing tantalum condenser is manufactured through a more simplified and higher-efficient process using simpler and economical equipment. The method of manufacturing a tantalum condenser including: sintering a tantalum powder to prepare a tantalum pellet; oxidizing the tantalum pellet to form a dielectric layer on a surface thereof; and depositing a polymer on the tantalum pellet by immersing the tantalum pellet having the dielectric layer formed on the surface thereof in a polymer suspension.

### CROSS-REFERENCE TO RELATED APPLICATIONS

This application claims the priority of Korean Patent Application No. 2007-26573 filed on Mar. 19, 2007, in the Korean Intellectual Property Office, the disclosure of which is incorporated herein by reference.

### BACKGROUND OF THE INVENTION

1. Field of the Invention

The present invention relates to a method of manufacturing a tantalum condenser, and more particularly, to a method of manufacturing a tantalum condenser, in which a high-performing tantalum condenser is manufactured through a more simplified and higher-efficient process using simpler and economical equipment.

2. Description of the Related Art

A tantalum condenser utilizes tantalum Ta as an electrode. That is, tantalum is a conductor but turned into a high-quality insulator when oxidized. When it comes to a tantalum condenser, the tantalum is oxidized as an anode into dielectrics and then an additional cathode is formed. The tantalum condenser is obtained by utilizing pores generated when tantalum powder is sintered and hardened.

There are two types of tantalum condensers. One is a wet tantalum condenser which employs an electrolyte solution and has a silver Ag case formed at a cathode to prevent the electrolyte solution from leaking. The other one is a dry tantalum condenser which uses a solid such as manganese dioxide as an electrolyte without adopting the electrolyte solution.

FIG. 1 is a flow chart illustrating a conventional method of manufacturing a tantalum condenser. To manufacture the tantalum condenser, first, tantalum powder is sintered to form a pellet and oxidized through chemical formation in operation S10. The oxidized tantalum pellet having dialectics formed thereon is immersed in a monomer-containing solution so that monomers are infiltrated into a surface of the dielectrics inside the porous tantalum pellet in operation S20. After being immersed, the tantalum pellet is dried to disperse the infiltrated monomers uniformly on the dielectrics in operation S30. The dried tantalum pellet is immersed in an oxidant solution containing a dopant to obtain a conductive polymer layer through chemical polymerization of the monomers in operation S40. The obtained tantalum pellet is dried in operation S50, and cleaned to remove impurities such as the residual oxidant solution in operation S60. The cleaning process may be conducted in two steps. That is, the oxidant solution is removed using a solution having strong reactivity with the oxidant solution, e.g., p-toluene sulfonic acid (p-TSA) and then the p-TSA is removed.

Subsequently, it is checked whether the polymer layer has been formed to function sufficiently well as a cathode layer in operation in S70. In a case where the cathode layer, i.e., polymer layer is not formed fully in operation S70: N, the tantalum pellet is immersed back in the monomer-containing solution as in operation S20, dried, immersed in the oxidant solution, dried and cleaned as in operations S30 to S60. These procedures are generally repeated four to fifteen times. With the cathode layer formed in operation S70: Y, the manufacturing method of the tantalum condenser is completed.

Alternatively, the operation of immersing the tantalum pellet in the monomer solution and the operation of immersing the dried tantalum pellet in the oxidant solution may not be performed separately. The tantalum pellet may be immersed in a single solution having the monomers and oxidant mixed therein. Here, the tantalum pellet having the dielectrics formed thereon is immersed in the solution containing the monomers and oxidant, and then dried and cleaned repeatedly to form the cathode layer. These monomers and oxidant are typically high-priced and strongly reactive, thus potentially lowering yield due to contamination of reactive solution during the process. Also, polymerization does not occur on a flat surface of a tantalum polymer but in minute pores, thus rendering it hard to control reaction. Therefore, in a case where the monomers are directly polymerized during the process, the monomers may suffer loss due to difficulty in controlling reaction.

Especially, the polymer layer should be formed in the pores of the tantalum pellet by polymerization. Here, to ensure the polymer layer to be formed suitably in the narrow pores, the monomers should be distributed adequately. Moreover, the distributed polymers should gain conductivity characteristics by doping. However, such polymerization is not easy to control in a process designed to achieve mass production. In addition, the strong reaction of the monomers and oxidants leads to contamination of the reactive solution, and consequently shorter useful life thereof. For this reason, the conventional method of manufacturing the tantalum condenser has drawbacks.

Further, after being immersed in the monomer solution, the tantalum pellet should be dried before being immersed in the oxidant solution, and then dried again and cleaned after being immersed in the oxidant solution. However, to enhance purity of the cathode layer and manufacture the tantalum condenser with excellent characteristics, the tantalum pellet should be sufficiently cleaned. This cleaning process degrades efficiency and ruins inter-process balance.

Therefore, there have been continued demands for a method of manufacturing a tantalum condenser in a more simplified and economical fashion while maintaining or increasing performance of the tantalum condenser.

### SUMMARY OF THE INVENTION

An aspect of the present invention provides a method of manufacturing a high-performing tantalum condenser, in which a tantalum condenser is manufactured through a more simplified and higher-efficient process using simpler and economical equipment.

According to an aspect of the present invention, there is provided a method of manufacturing a tantalum condenser, the method including: sintering a tantalum powder to prepare a tantalum pellet; oxidizing the tantalum pellet to form a dielectric layer on a surface thereof; and depositing a polymer on the tantalum pellet by immersing the tantalum pellet having the dielectric layer formed on the surface thereof in a polymer suspension. The polymer suspension may have nano-scale polymers suspended therein.

The polymer suspension may be a conductive polymer suspension. The polymer suspension may be formed of one selected from a group consisting of polythiophene, polyimide, polypyrrole, polyanailine, and polyfuran. The polymer suspension may include a conductive polymer, a dispersant and a surfactant.

The method may further include drying the tantalum pellet having the polymer deposited thereon. The drying the tantalum pellet may be performed at a temperature of 25° C. to 150° C.

The depositing a polymer and the drying the tantalum pellet may be repeated until the polymer is completely deposited. The depositing a polymer and the drying the tantalum pellet may be repeated four times or more.

The method may further include depositing the polymer using a monomer solution and an oxidant solution, after the drying the tantalum pellet.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart illustrating a conventional method of manufacturing a tantalum condenser;

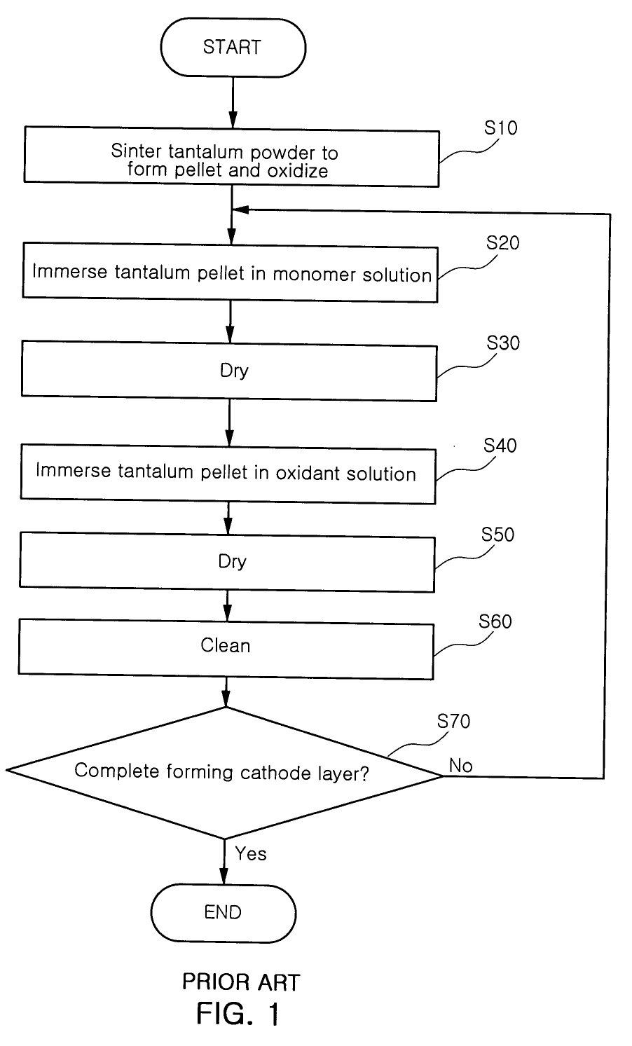

FIG. 2 is a flow chart illustrating a method of manufacturing a tantalum condenser according to an exemplary embodiment of the invention;

FIG. 3 is a view illustrating a tantalum pellet immersed in a polymer suspension in a method of manufacturing a tantalum condenser according to an exemplary embodiment of the invention; and

FIG. 4 is a graph illustrating capacitance and damping factor loss of tantalum condensers manufactured according to a conventional method and according to an exemplary embodiment of the invention, respectively, after the immersing and drying are repeated one to twenty times.

### DETAILED DESCRIPTION OF THE PREFERRED EMBODIMENT

Exemplary embodiments of the present invention will now be described in detail with reference to the accompanying drawings.

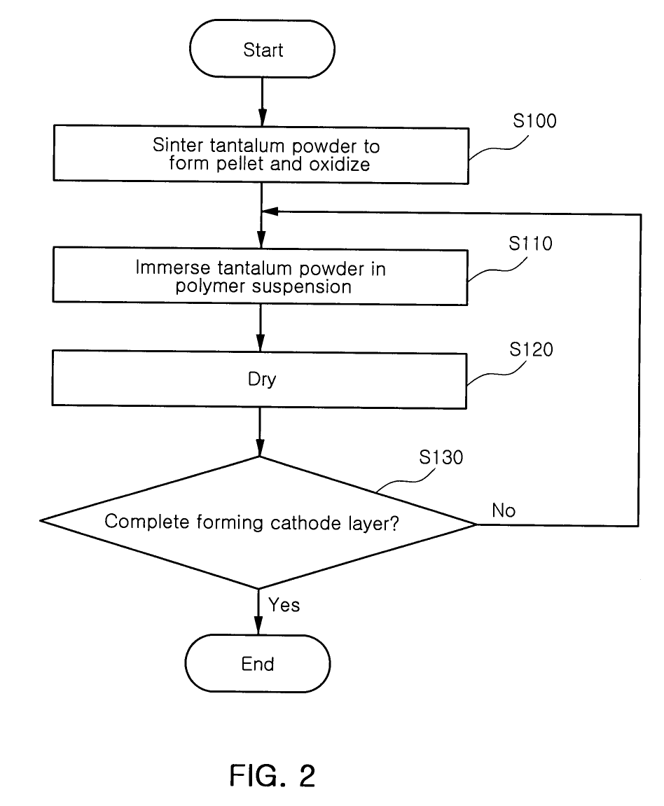

FIG. 2 is a flow chart illustrating a method of manufacturing a tantalum condenser according to an exemplary embodiment of the invention.

In the method of manufacturing the tantalum condenser, a tantalum powder is sintered to produce a tantalum pellet. The tantalum pellet is oxidized to form a dielectric layer on a surface thereof. The tantalum pellet having a dielectric layer formed on the surface thereof is immersed in a polymer suspension having nano-scale polymers suspended therein to deposit the polymers on the tantalum pellet having the dielectric layer formed on the surface thereof.

To manufacture the tantalum condenser, first, the tantalum powder is sintered to produce the tantalum pellet and the tantalum pellet is oxidized in operation S100. The tantalum powder is mixed with a binder or solvent before being sintered to enhance binding force and fluidity of particles. The tantalum powder mixed with the binder is compacted into a pellet with a desired size. Such compacting may be performed by a press method using a mold. For example, the tantalum pellet may be sintered within a sintering furnace in a high vacuum and at a high temperature. For example, the tantalum pellet may be sintered at a pressure of 1.0×10⁻⁷ Torr and at a temperature of 1300° C. to 2000° C.

The tantalum pellet obtained is oxidized through chemical formation. A tantalum oxide Ta₂O₅ is formed on the surface of the tantalum pellet and pores generated by sintering. The tantalum oxide serves as a dielectric layer.

A tantalum line may be extended from the tantalum pellet to facilitate processes such as chemical formation or cathode layer formation before the tantalum powder is sintered. Therefore, for the chemical formation, the tantalum line extended from the tantalum pellet is bonded to a metal plate. Then, voltages are applied to a metal plate and a chemical formation solution, respectively to form an oxide on the surface of the tantalum pellet. The tantalum oxide formed functions as a dielectric layer in the tantalum condenser.

When the tantalum pellet is prepared and the tantalum oxide is formed, the tantalum pellet is immersed in a polymer suspension in operation S110. Polymers are previously polymerized and dispersed in the polymer suspension with a size such that the polymers can be deposited into the tantalum pellet. The depositable size means a size enabling the polymers to be infiltrated into the tantalum pellet having minute pores with less than 10 μm. For example, the depositable size means a nanoscale. The polymers form the polymer layer inside and outside the tantalum pellet.

The polymers may be a conductive polymer. The conductive polymer means a polymer having a conductivity of at least 10⁻⁷ S/cm, i.e., a value greater than or equal to a conductivity of a semiconductor. Typically, a conductive polymer can have a high conductivity by doping electron receptors or electron donors in the polymers.

The polymer layer is formed to function as a cathode layer of the tantalum condenser, and thus should have a predetermined conductivity. The conductive polymer may adopt any conductive polymers that can be utilized as a cathode. For example, the conductive polymers may utilize one of polythiophene, polyimide, polypyrrole, polyanailine, and polyfuran. The conductive polymers may be polymerized into a predetermined depositable size in the tantalum pellet by adjusting a molecular weight thereof.

Also, the polymer suspension may include a dispersant, i.e., a supplemental agent capable of dispersing the conductive polymers to be present as small particles such as colloidal polymers in the suspension. The dispersant is added to prevent agglomeration of fine particles generated when pulverizing big particles and agglomerated particles into smaller particles and colloidal particles. A dispersant typically utilizes an adsorptive material such as a surfactant.

After being immersed in the polymer suspension, the tantalum pellet is dried to remove the polymer suspension in operation S120. The drying process is performed at a predetermined temperature considering characteristics of the polymer suspension, i.e., characteristics of the conductive polymers and dispersant. For example, the tantalum pellet may be dried at a room humidity of 65% RH and at a temperature of 25° C. to 150° C.

After the drying process, it is checked whether the cathode layer has been completely formed in operation S130. In a case where the cathode layer, i.e. polymer layer has not been completely formed as in operation S130: N, the tantalum pellet is immersed back in the polymer suspension in operation S110, and then dried in operation S120. The tantalum pellet may be immersed back in the polymer suspension and dried repeatedly until the polymers are completely deposited. The repeated number of times may be four or more. The immersing and drying repeated less than four times do not ensure the cathode layer to be formed sufficiently, thereby ill-affecting performance of the tantalum condenser. Also, the repeated number of times does not need to exceed twenty. The immersing and drying repeated twenty times ensure the polymers to be deposited sufficiently. It is apparent in the art that an upper limit of the repeated number of times may be easily set by those skilled in the art.

Moreover, after the drying process, in addition to depositing the polymers by immersing the tantalum pellet in the polymer suspension, the polymers may be deposited using a monomer solution and an oxidant solution

Completion of the cathode layer S130: Y is followed by processes such as having the cathode layer contact a lead frame for connection with an external power, forming an electrode line for leading out an electrode and sealing with a resin thereby to manufacture the tantalum condenser.

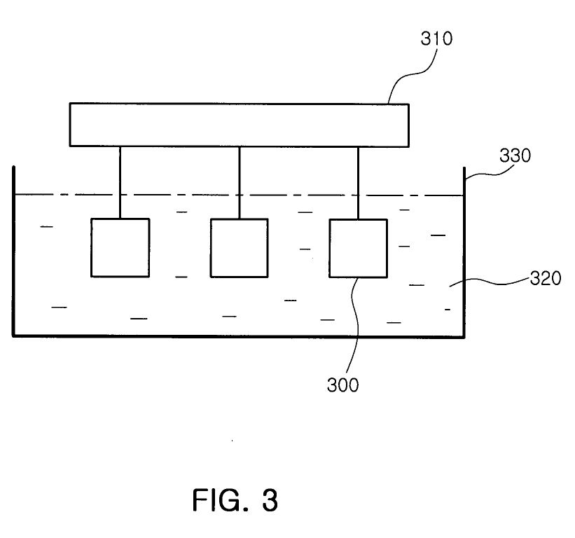

FIG. 3 illustrates a tantalum pellet immersed in the polymer suspension in manufacturing the tantalum condenser according to an exemplary embodiment of the present invention. The tantalum pellet 300 is connected to a metal plate and the metal plate 310 supports the tantalum pellet 300 to keep immersed in the polymer suspension 320.

The tantalum pellet 300 is surrounded by the polymer suspension 320 in a dipping bath 330. Accordingly, conductive polymer particles dispersed in the polymer suspension 320 are deposited into the tantalum pellet 300. After a predetermined time passes, the tantalum pellet 300 is taken out from the dipping bath 330, and then dried. When it is determined that the cathode layer has not been completely formed, the pellet 300 is immersed back in the polymer suspension 320 in the dipping bath 330.

The polymer layer is formed using the polymer suspension 320 containing the impurity-free polymer particles dispersed in a nanoscale. This precludes a need for a cleaning process for removing impurities. This accordingly ensures the tantalum condenser to be manufactured in a more simplified process, through simpler equipment, and also at lower material costs. Furthermore, this simplified process can reduce lead time and assure easier quality management.

### Embodiment

Hereinbelow, tantalum condensers of Inventive Examples 1 to 6 were manufactured, in which polymer layers were formed by depositing polymers using a polymer suspension according to a manufacturing method of an exemplary embodiment of the invention. Also, a tantalum condenser of Comparative Example 1 was manufactured by a conventional method. Then Inventive Examples 1 to 6 and Comparative Example 1 were measured in several characteristics. In this Embodiment, the present invention will be described by way of Examples but it should be apparently understood that such Examples will not limit the present invention.

### Inventive Examples 1 to 6

Inventive examples 1 to 6 were varied in an immersion rate and a drying temperature of tantalum pellets. The immersion rate and the drying temperature of Inventive examples 1 to 6 are noted in Table 1.

TABLE 1

| | Deposition | Drying temperature |
|---|---|---|
| | rate(mm/sec) | (° C.) |
| Inventive Example 1 | 0.1 | 80 |
| Inventive Example 2 | 0.5 | 80 |
| Inventive Example 3 | 1 | 80 |
| Inventive Example 4 | 0.1 | 25 |
| Inventive Example 5 | 0.1 | 80 |
| Inventive Example 6 | 0.1 | 150 |

### Comparative Example 1

The tantalum condenser of Comparative example 1 was manufactured by immersing a tantalum pellet in a monomer solution and an oxidant solution in forming a polymer layer, i.e., cathode layer.

### Evaluation

As shown in Table 1, Inventive Examples 1 to 6, and Comparative example 1 were measured in performance of tantalum condensers at 25V, and 15 μF, specifically, capacitance (C), damping factor (DF), equivalent series resistance (ESR), and LC defect.

TABLE 2

| | | | ESR | |
|---|---|---|---|---|
| | C (μF) | DF (%) | (mΩ) | LC defect rate (%) |
| Inventive Example 1 | 14.9 | 0.8 | 31 | up to 10% |
| Inventive Example 2 | 14.8 | 0.9 | 33 | up to 10% |
| Inventive Example 3 | 14.6 | 0.9 | 34 | up to 10% |
| Inventive Example 4 | 15.1 | 1.2 | 43 | up to 10% |
| Inventive Example 5 | 14.9 | 0.8 | 31 | up to 10% |
| Inventive Example 6 | 14.5 | 1.0 | 36 | up to 10% |
| Comparative Example 1 | 14.5 | 1.0 | 42 | up to 10% |

As can be seen in Table 1, the tantalum condensers of Inventive Examples 1 to 6 in which polymer layers were formed using a polymer suspension exhibit performance similar to or higher than the tantalum condenser of Comparative Example 1 conventionally manufactured using the monomer solution and oxidant solution. Therefore, it has been found that the tantalum condenser can be manufactured in a more simplified and higher-efficient process while maintaining similar performance according to the present embodiment.

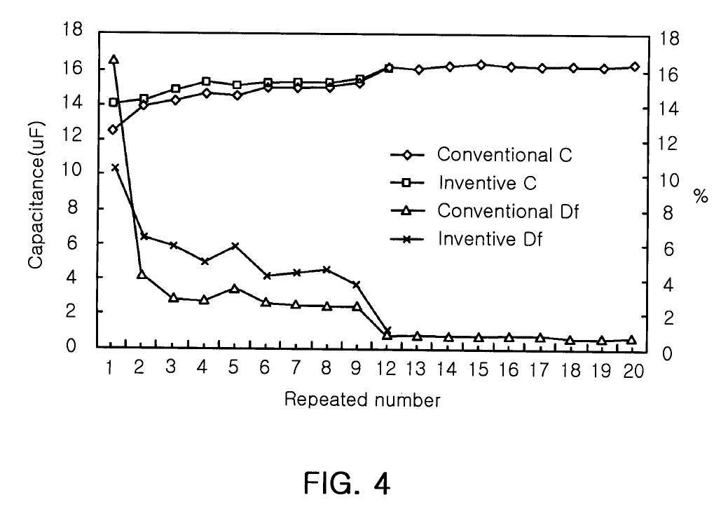

FIG. 4 is a graph illustrating capacitance and damping factor loss of tantalum condensers manufactured according to a conventional method and an exemplary embodiment of the invention, respectively by repeating immersing of tantalum pellets in a polymer suspension and drying of the tantalum pellets one to twenty times.

Referring to FIG. 4, in a case where the immersing and drying are repeated once, capacitance showed considerable loss. Meanwhile, the immersing and drying repeated at least four times ensured an acceptable level of loss in capacitance. Therefore, the immersing and drying may be repeated at least four times.

The embodiments of the present invention are only exemplary but do not limit the present invention. Embodiments with substantially identical construction and operational effects to technical feature of the claims of the present invention shall fall within the technical scope of the present invention.

As set forth above, according to exemplary embodiments of the invention, a method of manufacturing a tantalum condenser only involves immersing and drying without requiring cleaning, thereby ensuring an overall process to be performed through simpler and economical equipment.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a tantalum condenser, the method comprising:
sintering a tantalum powder to prepare a tantalum pellet;
oxidizing the tantalum pellet to form a dielectric layer on a surface thereof; and
depositing a polymer on the tantalum pellet by immersing the tantalum pellet having the dielectric layer formed on the surface thereof in a polymer suspension.

2. The method of claim 1, wherein the polymer suspension has nano-scale polymers suspended therein.

3. The method of claim 1, wherein the polymer suspension is a conductive polymer suspension.

4. The method of claim 3, wherein the polymer suspension comprises one selected from a group consisting of polythiophene, polyimide, polypyrrole, polyanailine, and polyfuran.

5. The method of claim 1, wherein the polymer suspension comprises a conductive polymer, a dispersant and a surfactant.

6. The method of claim 1, further comprising drying the tantalum pellet having the polymer deposited thereon.

7. The method of claim 6, wherein the drying the tantalum pellet is performed at a temperature of 25° C. to 150° C.

8. The method of claim 6, wherein the depositing a polymer and the drying the tantalum pellet are repeated until the polymer is completely deposited.

9. The method of claim 8, wherein the depositing a polymer and the drying the tantalum pellet are repeated four times or more.

10. The method of claim 6, further comprising depositing the polymer using a monomer solution and an oxidant solution, after the drying the tantalum pellet.
